(19) United States
(12) Patent Application Publication
(10) Pub. No.: US 2023/0370579 A1
(43) Pub. Date: Nov. 16, 2023

(54) METHODS OF VISUAL CAMERA PLANNING

(71) Applicant: AiFi Corp, Santa Clara, CA (US)

(72) Inventor: Tyler Crain, Santa Clara, CA (US)

(73) Assignee: AiFi Corp, Santa Clara, CA (US)

(21) Appl. No.: 17/742,395

(22) Filed: May 12, 2022

(51) Int. Cl. H04N 17/00; G06T 17/00; H04N 7/18; G06V 20/52; G06Q 20/40

(52) U.S. Cl. CPC H04N 17/002; G06Q 20/4016; G06T 17/00; G06V 20/52; H04N 7/181

(57) ABSTRACT

This application relates to systems, methods, devices, and other techniques for systems, methods, devices, and other techniques for visually planning camera setup within a retail environment.

### BACKGROUND OF THE INVENTION

This application relates to systems, methods, devices, and other techniques for visually planning camera setup within a retail environment.

Methods and apparatus for using cameras in a retail store for monitoring products and customers are well known and in practices. However, systems, methods, devices, and other techniques for systems, methods, devices, and other techniques for visually planning camera setup within a retail environment are not known.

Therefore, it is desirable to have systems, methods, devices, and other techniques for visually planning camera setup within a retail environment.

### SUMMARY OF THE INVENTION

This application relates to systems, methods, devices, and other techniques for visually planning camera setup within a retail environment.

In some embodiments, the invention is related to a method for selecting the position and orientation of one or more surveillance cameras in an area.

In some embodiments, the method comprises a step of receiving data about the area by a processor, wherein the area is configured to be a shop, wherein the area comprises at least one surveillance area, wherein the at least one surveillance area comprises multiple zones with different surveillance requirements, wherein some of the multiple zones are configured to be rectangular, wherein sizes of the multiple zones are determined by camera resolution and tracking limitation, wherein multiple shelves exists in the at least one surveillance area, wherein multiple products exists in any of the multiple shelves.

In some embodiments, the method comprises a step of using the data to model a virtual area by the processor.

In some embodiments, the method comprises a step of generating a first 3-D simulated view of the one or more surveillance cameras based on a default setup of the position and orientation of the one or more surveillance cameras, wherein the one or more surveillance cameras comprise any of tracking cameras, fixture cameras, server monitor cameras, entry and exit cameras, wherein the tracking cameras are configured to track any moving persons or objects, wherein the fixture cameras are configured to monitor product shelves and items on the product shelves, wherein the sever monitor cameras are configured to monitor servers in the area, wherein the entry and exit cameras are configured to monitor places near to entry and exit of the area, wherein the entry and exit cameras is configured to record payment method of any person entering the area, wherein the tracking cameras are configured to track any person entering the area and linking the any person with the payment method of the any person.

In some embodiments, the method comprises a step of calculating a first series of coverages and overlaps of one or more of any points by the one or more surveillance cameras within the area based on the first 3-D simulated view of the one or more surveillance cameras;

In some embodiments, the method comprises a step of generating another set of 3-D simulated views of the one or more surveillance cameras based on a set of changed setup of the position and orientation of the one or more surveillance cameras, wherein the set of changed setup of the position and orientation of the one or more surveillance cameras is initiated by a user or an automatic system, wherein the set of setup of the position and orientation of the one or more surveillance cameras is configured to be adjustable in a 2-D simulated environment, wherein special places in the area are labeled as being blocked, wherein the special places cannot be tracked by the one or more surveillance cameras, wherein the special places are physically isolated or are posted a warning sign to prevent customers to enter.

In some embodiments, the method comprises a step of calculating multiple series of coverages and overlaps of one or more of any points by the one or more surveillance cameras within the area based on the another set of 3-D simulated views of the one or more surveillance cameras.

In some embodiments, the method comprises a step of generating an optimized set of changed setup of the position and orientation of the one or more surveillance cameras to achieve an optimized result for coverage and overlaps of the one or more of any points in the area by the one or more surveillance cameras, wherein each product of the multiple products needs at least three cameras’ coverage.

In some embodiments, the method comprises a step of sending an alert if any abnormalities are detected by the one or more surveillance cameras, wherein the any abnormalities comprise events when any person enters the special places.

In some embodiments, invention is related to a method for selecting the position and orientation of one or more surveillance cameras in an area.

In some embodiments, the method comprises a step of receiving data about the area by a processor, wherein the area is configured to be a shop, wherein the area comprises at least one surveillance area, wherein the at least one surveillance area comprises multiple zones with different surveillance requirements, wherein some of the multiple zones are configured to be rectangular, wherein sizes of the multiple zones are determined by camera resolution and tracking limitation, wherein multiple shelves exists in the at least one surveillance area, wherein multiple products exists in any of the multiple shelves.

In some embodiments, the method comprises a step of using the data to model a virtual area by the processor.

In some embodiments, the method comprises a step of generating a first 3-D simulated view of the one or more surveillance cameras based on a default setup of the position and orientation of the one or more surveillance cameras, wherein the one or more surveillance cameras comprise any of tracking cameras, fixture cameras, server monitor cameras, entry and exit cameras, wherein the tracking cameras are configured to track any moving persons or objects, wherein the fixture cameras are configured to monitor product shelves and items on the product shelves, wherein the sever monitor cameras are configured to monitor servers in the area, wherein the entry and exit cameras are configured to monitor places near to entry and exit of the area, wherein the entry and exit cameras is configured to record payment method of any person entering the area, wherein the tracking cameras are configured to track any person entering the area and linking the any person with the payment method of the any person.

In some embodiments, the method comprises a step of calculating a first series of coverages and overlaps of one or more of any points by the one or more surveillance cameras within the area based on the first 3-D simulated view of the one or more surveillance cameras;

In some embodiments, the method comprises a step of generating another set of 3-D simulated views of the one or more surveillance cameras based on a set of changed setup of the position and orientation of the one or more surveillance cameras, wherein the set of changed setup of the position and orientation of the one or more surveillance cameras is initiated by a user or an automatic system, wherein the set of setup of the position and orientation of the one or more surveillance cameras is configured to be adjustable in a 2-D simulated environment, wherein special places in the area are labeled as being blocked, wherein the special places cannot be tracked by the one or more surveillance cameras, wherein the special places are physically isolated or are posted a warning sign to prevent customers to enter.

In some embodiments, the method comprises a step of calculating multiple series of coverages and overlaps of one or more of any points by the one or more surveillance cameras within the area based on the another set of 3-D simulated views of the one or more surveillance cameras.

In some embodiments, the method comprises a step of generating an optimized set of changed setup of the position and orientation of the one or more surveillance cameras to achieve an optimized result for coverage and overlaps of the one or more of any points in the area by the one or more surveillance cameras, wherein each product of the multiple products needs at least three cameras’ coverage.

In some embodiments, invention is related to a method for selecting the position and orientation of one or more surveillance cameras in an area.

In some embodiments, the method comprises a step of receiving data about the area by a processor, wherein the area comprises at least one surveillance area, wherein the at least one surveillance area comprises multiple zones with different surveillance requirements, wherein some of the multiple zones are configured to be rectangular, wherein sizes of the multiple zones are determined by camera resolution and tracking limitation, wherein multiple shelves exists in the at least one surveillance area, wherein multiple products exists in any of the multiple shelves.

In some embodiments, the method comprises a step of using the data to model a virtual area by the processor.

In some embodiments, the method comprises a step of generating a first 3-D simulated view of the one or more surveillance cameras based on a default setup of the position and orientation of the one or more surveillance cameras, wherein the one or more surveillance cameras comprise any of tracking cameras, fixture cameras, server monitor cameras, entry and exit cameras, wherein the tracking cameras are configured to track any moving persons or objects, wherein the fixture cameras are configured to monitor product shelves and items on the product shelves, wherein the sever monitor cameras are configured to monitor servers in the area, wherein the entry and exit cameras are configured to monitor places near to entry and exit of the area, wherein the entry and exit cameras is configured to record payment method of any person entering the area, wherein the tracking cameras are configured to track any person entering the area and linking the any person with the payment method of the any person.

In some embodiments, the method comprises a step of calculating a first series of coverages and overlaps of one or more of any points by the one or more surveillance cameras within the area based on the first 3-D simulated view of the one or more surveillance cameras;

In some embodiments, the method comprises a step of generating another set of 3-D simulated views of the one or more surveillance cameras based on a set of changed setup of the position and orientation of the one or more surveillance cameras, wherein the set of changed setup of the position and orientation of the one or more surveillance cameras is initiated by a user or an automatic system, wherein the set of setup of the position and orientation of the one or more surveillance cameras is configured to be adjustable in a 2-D simulated environment, wherein special places in the area are labeled as being blocked, wherein the special places cannot be tracked by the one or more surveillance cameras, wherein the special places are physically isolated or are posted a warning sign to prevent customers to enter.

In some embodiments, the method comprises a step of calculating multiple series of coverages and overlaps of one or more of any points by the one or more surveillance cameras within the area based on the another set of 3-D simulated views of the one or more surveillance cameras.

In some embodiments, the method comprises a step of generating an optimized set of changed setup of the position and orientation of the one or more surveillance cameras to achieve an optimized result for coverage and overlaps of the one or more of any points in the area by the one or more surveillance cameras, wherein each product of the multiple products needs at least three cameras’ coverage.

These and other aspects, their implementations and other features are described in details in the drawings, the description and the claims.

### BRIEF DESCRIPTION OF THE DRAWINGS

FIG. 1 shows a method of visually planning camera setup within a retail environment.

FIG. 2 shows a second method of visually planning camera setup within a retail environment.

FIG. 3 shows a third method of visually planning camera setup within a retail environment.

### DETAILED DESCRIPTION OF THE INVENTION

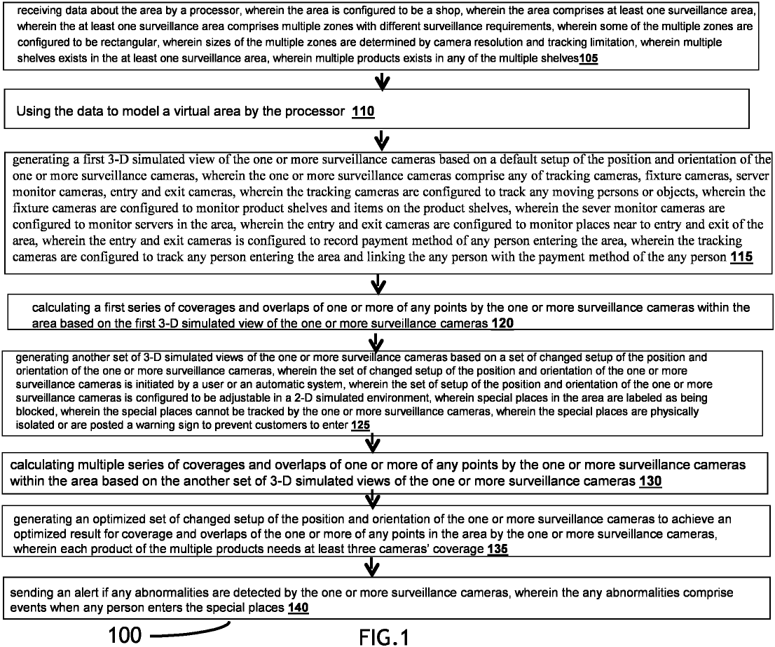

FIG. 1 shows a method 100 of visually planning camera setup within a retail environment.

In some embodiments, the method comprises a step 105 of receiving data about the area by a processor, wherein the area is configured to be a shop, wherein the area comprises at least one surveillance area, wherein the at least one surveillance area comprises multiple zones with different surveillance requirements, wherein some of the multiple zones are configured to be rectangular, wherein sizes of the multiple zones are determined by camera resolution and tracking limitation, wherein multiple shelves exists in the at least one surveillance area, wherein multiple products exists in any of the multiple shelves.

In some embodiments, the method comprises a step 110 of using the data to model a virtual area by the processor.

In some embodiments, the method comprises a step 115 of generating a first 3-D simulated view of the one or more surveillance cameras based on a default setup of the position and orientation of the one or more surveillance cameras, wherein the one or more surveillance cameras comprise any of tracking cameras, fixture cameras, server monitor cameras, entry and exit cameras, wherein the tracking cameras are configured to track any moving persons or objects, wherein the fixture cameras are configured to monitor product shelves and items on the product shelves, wherein the sever monitor cameras are configured to monitor servers in the area, wherein the entry and exit cameras are configured to monitor places near to entry and exit of the area, wherein the entry and exit cameras is configured to record payment method of any person entering the area, wherein the tracking cameras are configured to track any person entering the area and linking the any person with the payment method of the any person.

In some embodiments, the method comprises a step 120 of calculating a first series of coverages and overlaps of one or more of any points by the one or more surveillance cameras within the area based on the first 3-D simulated view of the one or more surveillance cameras;

In some embodiments, the method comprises a step 125 of generating another set of 3-D simulated views of the one or more surveillance cameras based on a set of changed setup of the position and orientation of the one or more surveillance cameras, wherein the set of changed setup of the position and orientation of the one or more surveillance cameras is initiated by a user or an automatic system, wherein the set of setup of the position and orientation of the one or more surveillance cameras is configured to be adjustable in a 2-D simulated environment, wherein special places in the area are labeled as being blocked, wherein the special places cannot be tracked by the one or more surveillance cameras, wherein the special places are physically isolated or are posted a warning sign to prevent customers to enter.

In some embodiments, the method comprises a step 130 of calculating multiple series of coverages and overlaps of one or more of any points by the one or more surveillance cameras within the area based on the another set of 3-D simulated views of the one or more surveillance cameras.

In some embodiments, the method comprises a step 135 of generating an optimized set of changed setup of the position and orientation of the one or more surveillance cameras to achieve an optimized result for coverage and overlaps of the one or more of any points in the area by the one or more surveillance cameras, wherein each product of the multiple products needs at least three cameras’ coverage.

In some embodiments, the method comprises a step 140 of sending an alert if any abnormalities are detected by the one or more surveillance cameras, wherein the any abnormalities comprise events when any person enters the special places.

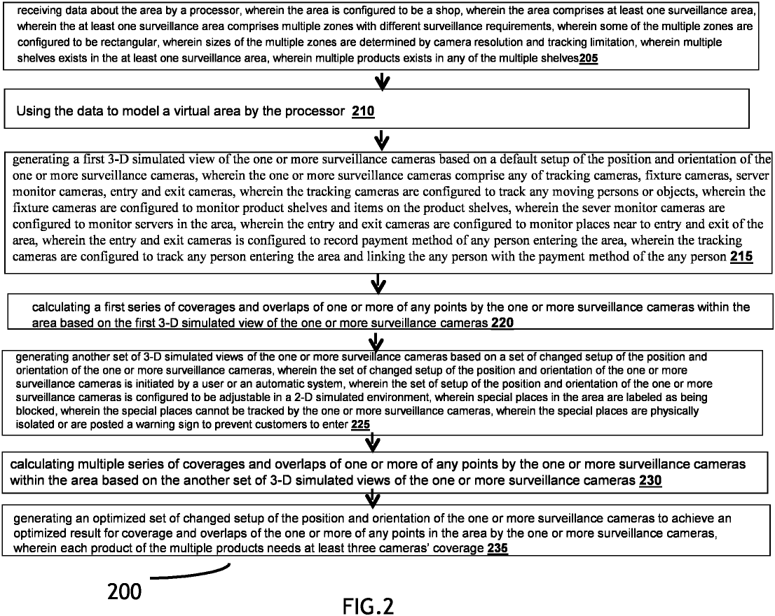

FIG. 2 shows a second method of visually planning camera setup within a retail environment.

In some embodiments, the method comprises a step 205 of receiving data about the area by a processor, wherein the area is configured to be a shop, wherein the area comprises at least one surveillance area, wherein the at least one surveillance area comprises multiple zones with different surveillance requirements, wherein some of the multiple zones are configured to be rectangular, wherein sizes of the multiple zones are determined by camera resolution and tracking limitation, wherein multiple shelves exists in the at least one surveillance area, wherein multiple products exists in any of the multiple shelves.

In some embodiments, the method comprises a step 210 of using the data to model a virtual area by the processor.

In some embodiments, the method comprises a step 215 of generating a first 3-D simulated view of the one or more surveillance cameras based on a default setup of the position and orientation of the one or more surveillance cameras, wherein the one or more surveillance cameras comprise any of tracking cameras, fixture cameras, server monitor cameras, entry and exit cameras, wherein the tracking cameras are configured to track any moving persons or objects, wherein the fixture cameras are configured to monitor product shelves and items on the product shelves, wherein the sever monitor cameras are configured to monitor servers in the area, wherein the entry and exit cameras are configured to monitor places near to entry and exit of the area, wherein the entry and exit cameras is configured to record payment method of any person entering the area, wherein the tracking cameras are configured to track any person entering the area and linking the any person with the payment method of the any person.

In some embodiments, the method comprises a step 220 of calculating a first series of coverages and overlaps of one or more of any points by the one or more surveillance cameras within the area based on the first 3-D simulated view of the one or more surveillance cameras;

In some embodiments, the method comprises a step 225 of generating another set of 3-D simulated views of the one or more surveillance cameras based on a set of changed setup of the position and orientation of the one or more surveillance cameras, wherein the set of changed setup of the position and orientation of the one or more surveillance cameras is initiated by a user or an automatic system, wherein the set of setup of the position and orientation of the one or more surveillance cameras is configured to be adjustable in a 2-D simulated environment, wherein special places in the area are labeled as being blocked, wherein the special places cannot be tracked by the one or more surveillance cameras, wherein the special places are physically isolated or are posted a warning sign to prevent customers to enter.

In some embodiments, the method comprises a step 230 of calculating multiple series of coverages and overlaps of one or more of any points by the one or more surveillance cameras within the area based on the another set of 3-D simulated views of the one or more surveillance cameras.

In some embodiments, the method comprises a step 235 of generating an optimized set of changed setup of the position and orientation of the one or more surveillance cameras to achieve an optimized result for coverage and overlaps of the one or more of any points in the area by the one or more surveillance cameras, wherein each product of the multiple products needs at least three cameras’ coverage.

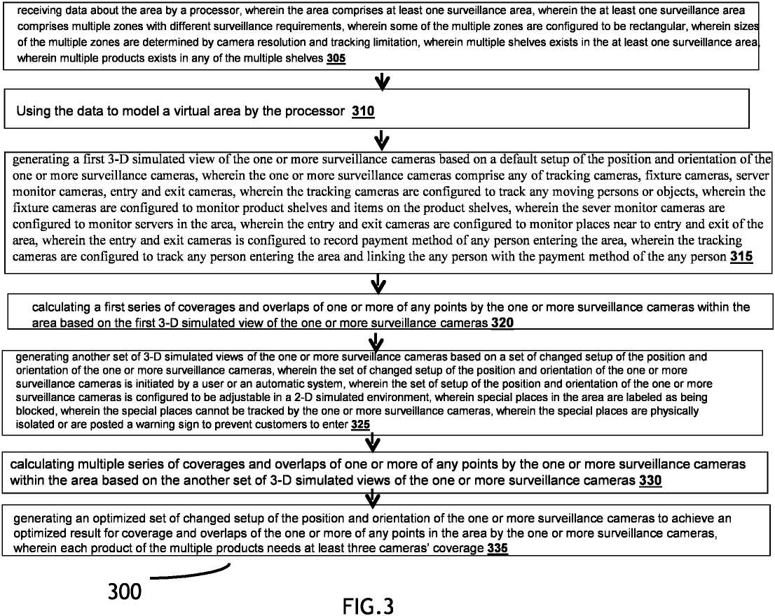

FIG. 3 shows a third method of visually planning camera setup within a retail environment.

In some embodiments, the method comprises a step 305 of receiving data about the area by a processor, wherein the area comprises at least one surveillance area, wherein the at least one surveillance area comprises multiple zones with different surveillance requirements, wherein some of the multiple zones are configured to be rectangular, wherein sizes of the multiple zones are determined by camera resolution and tracking limitation, wherein multiple shelves exists in the at least one surveillance area, wherein multiple products exists in any of the multiple shelves.

In some embodiments, the method comprises a step 310 of using the data to model a virtual area by the processor.

In some embodiments, the method comprises a step 315 of generating a first 3-D simulated view of the one or more surveillance cameras based on a default setup of the position and orientation of the one or more surveillance cameras, wherein the one or more surveillance cameras comprise any of tracking cameras, fixture cameras, server monitor cameras, entry and exit cameras, wherein the tracking cameras are configured to track any moving persons or objects, wherein the fixture cameras are configured to monitor product shelves and items on the product shelves, wherein the sever monitor cameras are configured to monitor servers in the area, wherein the entry and exit cameras are configured to monitor places near to entry and exit of the area, wherein the entry and exit cameras is configured to record payment method of any person entering the area, wherein the tracking cameras are configured to track any person entering the area and linking the any person with the payment method of the any person.

In some embodiments, the method comprises a step 320 of calculating a first series of coverages and overlaps of one or more of any points by the one or more surveillance cameras within the area based on the first 3-D simulated view of the one or more surveillance cameras;

In some embodiments, the method comprises a step 325 of generating another set of 3-D simulated views of the one or more surveillance cameras based on a set of changed setup of the position and orientation of the one or more surveillance cameras, wherein the set of changed setup of the position and orientation of the one or more surveillance cameras is initiated by a user or an automatic system, wherein the set of setup of the position and orientation of the one or more surveillance cameras is configured to be adjustable in a 2-D simulated environment, wherein special places in the area are labeled as being blocked, wherein the special places cannot be tracked by the one or more surveillance cameras, wherein the special places are physically isolated or are posted a warning sign to prevent customers to enter.

In some embodiments, the method comprises a step 330 of calculating multiple series of coverages and overlaps of one or more of any points by the one or more surveillance cameras within the area based on the another set of 3-D simulated views of the one or more surveillance cameras.

In some embodiments, the method comprises a step 335 of generating an optimized set of changed setup of the position and orientation of the one or more surveillance cameras to achieve an optimized result for coverage and overlaps of the one or more of any points in the area by the one or more surveillance cameras, wherein each product of the multiple products needs at least three cameras’ coverage.

1. A method for selecting the position and orientation of one or more surveillance cameras in an area, comprising:
receiving data about the area by a processor, wherein the area is configured to be a shop, wherein the area comprises at least one surveillance area, wherein the at least one surveillance area comprises multiple zones with different surveillance requirements, wherein some of the multiple zones are configured to be rectangular, wherein sizes of the multiple zones are determined by camera resolution and tracking limitation, wherein multiple shelves exists in the at least one surveillance area, wherein multiple products exists in any of the multiple shelves;
using the data to model a virtual area by the processor;
generating a first 3-D simulated view of the one or more surveillance cameras based on a default setup of the position and orientation of the one or more surveillance cameras, wherein the one or more surveillance cameras comprise any of tracking cameras, fixture cameras, server monitor cameras, entry and exit cameras, wherein the tracking cameras are configured to track any moving persons or objects, wherein the fixture cameras are configured to monitor product shelves and items on the product shelves, wherein the sever monitor cameras are configured to monitor servers in the area, wherein the entry and exit cameras are configured to monitor places near to entry and exit of the area, wherein the entry and exit cameras is configured to record payment method of any person entering the area, wherein the tracking cameras are configured to track any person entering the area and linking the any person with the payment method of the any person;
calculating a first series of coverages and overlaps of one or more of any points by the one or more surveillance cameras within the area based on the first 3-D simulated view of the one or more surveillance cameras;
generating another set of 3-D simulated views of the one or more surveillance cameras based on a set of changed setup of the position and orientation of the one or more surveillance cameras, wherein the set of changed setup of the position and orientation of the one or more surveillance cameras is initiated by a user or an automatic system, wherein the set of setup of the position and orientation of the one or more surveillance cameras is configured to be adjustable in a 2-D simulated environment, wherein special places in the area are labeled as being blocked, wherein the special places cannot be tracked by the one or more surveillance cameras, wherein the special places are physically isolated or are posted a warning sign to prevent customers to enter;
calculating multiple series of coverages and overlaps of one or more of any points by the one or more surveillance cameras within the area based on the another set of 3-D simulated views of the one or more surveillance cameras;
generating an optimized set of changed setup of the position and orientation of the one or more surveillance cameras to achieve an optimized result for coverage and overlaps of the one or more of any points in the area by the one or more surveillance cameras, wherein each product of the multiple products needs at least three cameras’ coverage; and
sending an alert if any abnormalities are detected by the one or more surveillance cameras, wherein the any abnormalities comprise events when any person enters the special places.

2. A method for selecting the position and orientation of one or more surveillance cameras in an area, comprising:
receiving data about the area by a processor, wherein the area is configured to be a shop, wherein the area comprises at least one surveillance area, wherein the at least one surveillance area comprises multiple zones with different surveillance requirements, wherein some of the multiple zones are configured to be rectangular, wherein sizes of the multiple zones are determined by camera resolution and tracking limitation, wherein multiple shelves exists in the at least one surveillance area, wherein multiple products exists in any of the multiple shelves;
using the data to model a virtual area by the processor;
generating a first 3-D simulated view of the one or more surveillance cameras based on a default setup of the position and orientation of the one or more surveillance cameras, wherein the one or more surveillance cameras comprise any of tracking cameras, fixture cameras, server monitor cameras, entry and exit cameras, wherein the tracking cameras are configured to track any moving persons or objects, wherein the fixture cameras are configured to monitor product shelves and items on the product shelves, wherein the sever monitor cameras are configured to monitor servers in the area, wherein the entry and exit cameras are configured to monitor places near to entry and exit of the area, wherein the entry and exit cameras is configured to record payment method of any person entering the area, wherein the tracking cameras are configured to track any person entering the area and linking the any person with the payment method of the any person;
calculating a first series of coverages and overlaps of one or more of any points by the one or more surveillance cameras within the area based on the first 3-D simulated view of the one or more surveillance cameras;
generating another set of 3-D simulated views of the one or more surveillance cameras based on a set of changed setup of the position and orientation of the one or more surveillance cameras, wherein the set of changed setup of the position and orientation of the one or more surveillance cameras is initiated by a user or an automatic system, wherein the set of setup of the position and orientation of the one or more surveillance cameras is configured to be adjustable in a 2-D simulated environment, wherein special places in the area are labeled as being blocked, wherein the special places cannot be tracked by the one or more surveillance cameras, wherein the special places are physically isolated or are posted a warning sign to prevent customers to enter;
calculating multiple series of coverages and overlaps of one or more of any points by the one or more surveillance cameras within the area based on the another set of 3-D simulated views of the one or more surveillance cameras; and
generating an optimized set of changed setup of the position and orientation of the one or more surveillance cameras to achieve an optimized result for coverage and overlaps of the one or more of any points in the area by the one or more surveillance cameras, wherein each product of the multiple products needs at least three cameras’ coverage.

3. A method for selecting the position and orientation of one or more surveillance cameras in an area, comprising:
receiving data about the area by a processor, wherein the area comprises at least one surveillance area, wherein the at least one surveillance area comprises multiple zones with different surveillance requirements, wherein some of the multiple zones are configured to be rectangular, wherein sizes of the multiple zones are determined by camera resolution and tracking limitation, wherein multiple shelves exists in the at least one surveillance area, wherein multiple products exists in any of the multiple shelves;
using the data to model a virtual area by the processor;
generating a first 3-D simulated view of the one or more surveillance cameras based on a default setup of the position and orientation of the one or more surveillance cameras, wherein the one or more surveillance cameras comprise any of tracking cameras, fixture cameras, server monitor cameras, entry and exit cameras, wherein the tracking cameras are configured to track any moving persons or objects, wherein the fixture cameras are configured to monitor product shelves and items on the product shelves, wherein the sever monitor cameras are configured to monitor servers in the area, wherein the entry and exit cameras are configured to monitor places near to entry and exit of the area, wherein the entry and exit cameras is configured to record payment method of any person entering the area, wherein the tracking cameras are configured to track any person entering the area and linking the any person with the payment method of the any person;
calculating a first series of coverages and overlaps of one or more of any points by the one or more surveillance cameras within the area based on the first 3-D simulated view of the one or more surveillance cameras;
generating another set of 3-D simulated views of the one or more surveillance cameras based on a set of changed setup of the position and orientation of the one or more surveillance cameras, wherein the set of changed setup of the position and orientation of the one or more surveillance cameras is initiated by a user or an automatic system, wherein the set of setup of the position and orientation of the one or more surveillance cameras is configured to be adjustable in a 2-D simulated environment, wherein special places in the area are labeled as being blocked, wherein the special places cannot be tracked by the one or more surveillance cameras, wherein the special places are physically isolated or are posted a warning sign to prevent customers to enter;
calculating multiple series of coverages and overlaps of one or more of any points by the one or more surveillance cameras within the area based on the another set of 3-D simulated views of the one or more surveillance cameras; and
generating an optimized set of changed setup of the position and orientation of the one or more surveillance cameras to achieve an optimized result for coverage and overlaps of the one or more of any points in the area by the one or more surveillance cameras, wherein each product of the multiple products needs at least three cameras’ coverage.
